(19) United States
(12) Patent Application Publication
(10) Pub. No.: US 2024/0392625 A1
(43) Pub. Date: Nov. 28, 2024

(54) FRAME WITH INCORPORATION OF PROTECTION AGAINST EXTERNAL LIGHT AND/OR LIGHTING

(71) Applicant: BBG, S.A, Esposende (PT)

(72) Inventor: Miguel SOUSA ARAÚJO, Esposende (PT)

(21) Appl. No.: 18/672,143

(22) Filed: May 23, 2024

(30) Foreign Application Priority Data
May 24, 2023 (PT) 118676

(51) Int. Cl. E06B 9/42; E06B 9/52

(52) U.S. Cl. CPC E06B 9/42; E06B 9/52

(57) ABSTRACT

The present invention concerns a frame for the manufacture of doors or windows incorporating protection against external light and/or lighting, preferably made of aluminium, applied to a door or window opening of a building (8), and comprising at least one fixed frame (10); panels or sash (1), these panels (1) being fixed or movable, with a movable frame (9) around their entire perimeter; means of protection against external light (3); and/or lighting means (2). Protection against external light (3) and lighting (2) can be inside or outside in relation to the lintel, and both are integrated into the system in a concealed way, being integrated into a housing profile (7) of the fixed frame (10) and located on the frame (10) at the lintel. Means of protection against external light (3) and lighting (2) have the possibility of being located inside and/or outside in relation to the panel (1).

### TECHNICAL FIELD

The present invention concerns a frame incorporating protection against external light and/or lighting, preferably minimalist, with the incorporation of means of protection against external light, natural and/or artificial, and also with the possibility of incorporating means of lighting, integrated into the system in a concealed way. This invention falls within the area of mechanical engineering applied to civil engineering, more specifically fixed construction elements.

### BACKGROUND OF THE INVENTION

For a better understanding of this type of objects, it is important to make an approach to the definitions known by experts, which is why it is defined in the context of this application that these windows or balconies have at least one movable panel (1), normally designated by sash, which has a movable frame (9) throughout its entire perimeter, this movable panel (1) is typically made of glass, which can be single, double, triple, etc. In addition to this movable panel (1)—and it is understood that when we refer to the movable panel (1) we are considering the movable frame (9) and glass(s) set-, we have a fixed frame (10) to the opening of the building where at least one movable panel (1) is installed.

Balconies are understood as openings in buildings (8) which not being doors for intensive use have a configuration similar to a window with a fixed perimeter frame or with a threshold of reduced height (up to a maximum of 20 mm), however they can extend in height from the ground (threshold) to the height of the ceiling, occupying a height corresponding to at least one double ceiling height considering the ceiling height fixed in European regulations, the highest, applicable to the construction, thus allowing a user to enter and exit the building through them, the typical balconies, porches, decks.

### SUMMARY OF THE DISCLOSURE

The present invention concerns a frame incorporating protection against external light and/or lighting, preferably minimalist and made of aluminium, and even preferably for large windows, with the incorporation of means of protection against external light (3), natural and/or artificial, and also with the possibility of incorporating of lighting means (2), integrated into the system in a concealed way for windows, doors and balconies, opening to the outside.

Thus, the present invention presents the following advantages compared to the aforementioned prior art:
elimination of the need for traditional blinds, reducing the complexity of construction; traditional curtains are also not necessary for privacy, as they have a dual function;
manual or automatic activation of protection against external light (3);
control of light transmission through the external light protection means (3), which has an impact on the solar factor Sw/light transmission and Ujn, and also on the control of the differential thermal transmission parameter between day/night protection;
reduction of light transmission to the interior;
reducing the overheating of the glass when the protection is also external, as well as controlling the conditions inside the house (light, temperature);
reduction in the cost associated with the electrical installation of exterior lighting elements, as they are integrated into the frames.

### DESCRIPTION OF FIGURES

FIG. 1—representation of a vertical section of the frame where the different features of the system are intended to be represented. The fixed frame (10) and the movable frame (9), also represent two panels (1), in this case both movable, where one is visible and the other must be on the opposite side of the fixed frame (10) (not representable in this case. The lighting means (2) and the means of protection against external light (3) can be seen, both of which are located inside the building in this embodiment (8). It is also possible to observe the openings (4) through which the lighting means (2) project and through which the means of protection against external light (3) slide through the rolling and unwinding movement, as well as that the lighting means (2) components and the means of protection against external light (3) are housed in the housing profile (7) of the fixed frame (10), located on the lintel. It is understood that the interior side of the building is the left side in the figure.

FIG. 2—representation of a vertical section of the frame, similar to FIG. 1, in this embodiment both lighting means (2) and protection against external light (3) are located inside the building (8). It is understood that the exterior side of the building is the right side in the figure.

FIG. 3—representation of a vertical section of the frame in the embodiment wherein both means of protection against external light (3) and means of lighting (2) are located at both the exterior and interior sides of the building, thus having two means protection (3), two means of lighting (2) and four openings (4). In this representation both panels (1) are visible.

FIG. 4—representation of a vertical section of the frame in the embodiment wherein both means of protection against external light (3) and means of lighting (2) are present at both the external and internal sides of the building, thus having two means protection (3), two means of lighting (2) and four openings (4) and a motorization system wherein the engine (6) is located. In this representation both leaves (1) are visible.

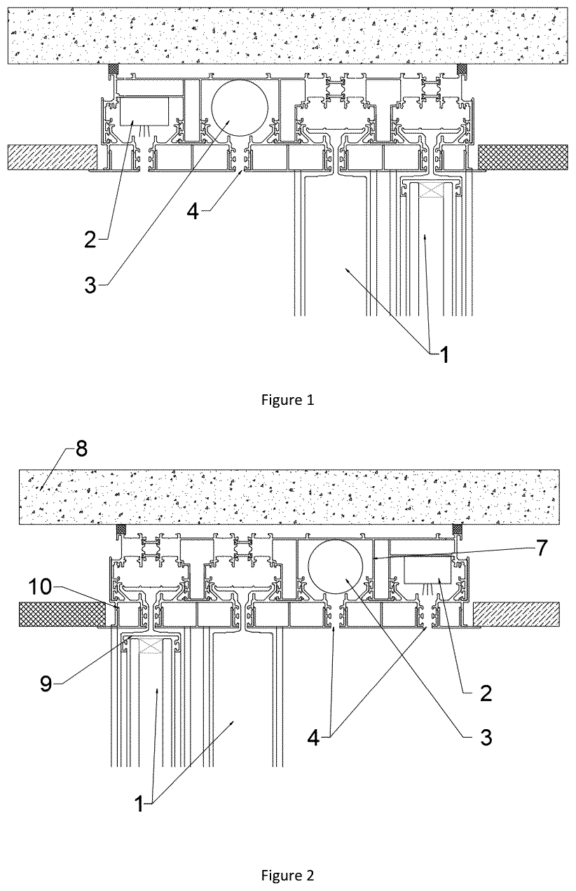

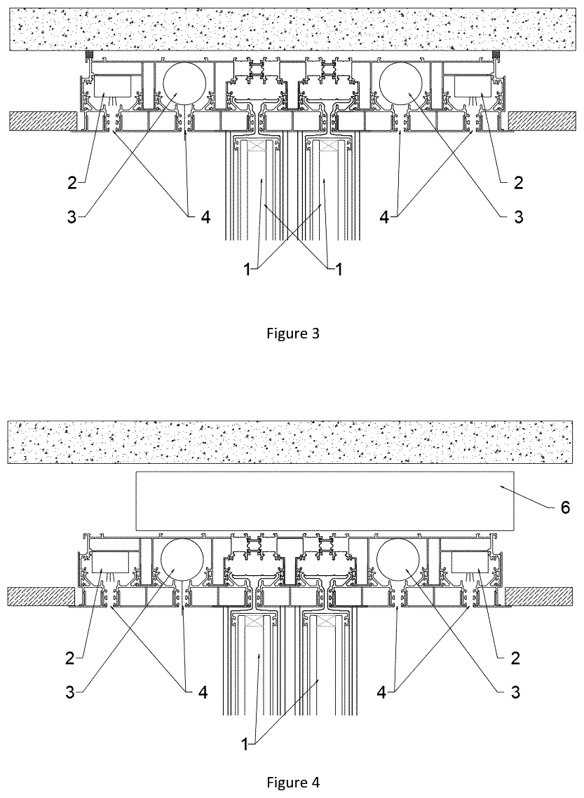

### DETAILED DESCRIPTION

The present invention concerns a frame for manufacturing doors or windows, preferably made of aluminium, which is applied to a door or window opening of a building (8), which has means of protection against external light (3), housed in a profile housing (7), said profile housing (7) located at the lintel of the fixed frame (10). The means of protection against external light (3) have a vertical movement along the panel (1), by sliding through an opening (4), located in the lintel of the fixed frame (10) and which has a preferential opening between 8 mm and 18 mm.

In a preferred embodiment of the present invention, the means of protection against external light (3) are preferably roller blinds, and can be moved by manual and/or electrical means. These blinds are inserted into rollers, which are rolled up or unrolled.

The present invention has the advantage of presenting the functionality of movement of the means of protection against external light (3), which can be manual or alternatively automatic, the latter remotely activating a motor (6). This motorized system for the movement of the external light protection means (3) is possible even in the event of no electrical power, since the electric motor (6) can be reversible, meaning that the motor can be rotated manually in the event of an electricity failure, making it possible to move the external light protection means (3) even without electricity. In order for the roller to have the automatic winding and unwinding movement, the present invention comprises torsion springs inserted into the roller, which promote the winding and unwinding movement protection against external light (3) alone.

It is added that the means of protection against external light (3), by means of gravity, through a weight located at its free end that crosses the opening (4) being suspended and protecting the entry of light, alternatively or complementing, these means protection against external light (3) can comprise a hitch or engagement, so that they remain in a fixed position along the jamb of the fixed frame (10), promoted, for example by the existence of fixing means along the jamb of the fixing frame (10), in the upward-descending movement and said fixed position can be variable, whatever the user decides.

The present invention may also present lighting means (2), housed in the housing profile (7) of the fixed frame (10) which project their light through a second opening (4) located in the lintel of the fixed frame (10).

The present invention may have means of protection against external light (3) and/or lighting means (2) on only one side of the frame, that is, only on one side of a jamb, thus having only one blind, for example, as can have on both sides, thus having two blinds, as, in the case of large windows, have as many as necessary, meaning there must be openings (4) and remaining components in the corresponding number.

In a preferred configuration of the present invention, the lighting means (2) are located on the outer sides relative to the means of protection against external light (3), that is, we have the panel (1), followed by the means of protection against external light (3) and, in turn, followed by the lighting means (2).

In a preferred embodiment of the present invention, the lighting means (2) are led.

In an alternative form of the present invention, a built-in light sensor (not shown) is used, which, through means known in the art, can activate the lighting means (2) facilitating external visibility.

In a more preferred embodiment, the lighting means (2) have the possibility of automatic switching on, that is, their automatic lowering or raising, depending on the brightness of the location identified by the incorporated light sensor.

In a preferred embodiment of the present invention, the light protection means (3) may be a net with an opening to protect against the entry of mosquitoes or dust, similar to a mosquito net.

It should be added that the light protection means (3) may be made of material that protects against Ultraviolet (UV) radiation.

In an alternative form of the present invention, a temperature sensor is used, and when the glass is overheating, it activates the sun protection means (3) located outside to stabilize the temperature of the glass.

For the invention to be self-sufficient, in the case of incorporating the various alternatives in full or in part, but being the same motorized and/or electric, the invention may alternatively feature integrated photovoltaic panels, so that powering these panels is possible. In this preferred embodiment the invention would have to comprise a battery that stores energy, concealed in the system, located in the housing profile (7) of the fixed frame (10).

It is common knowledge that for the insertion of the various aforementioned components it is necessary to carry out machining on the fixed frame (10), so that it receives the housing profile (7) and that this has to be adapted to receive the same components.

All embodiments presented are cases in which we have two double panels, that is, bi-rail frames, however, these panels can be made of single, double, triple glass panels, or other types of material and can be moved manually or automatically.

In a preferred embodiment of the present invention, the movable frame (9) and/or the fixed frame (10) are made of aluminium.

The present invention is essentially protected by claim 1, where it is clear that it may have one or more means of protection against external light (3) and/or one or more means of illumination (2), that these means of protection against external light exterior (3) and/or lighting means (2) are housed in housing profile(s) (7) of the fixed frame (10), and in the lintel area, in at least one location, as we can have one or more protections sliding across the leaves, which must have respective openings (4), to let light pass through, and to allow the protections to slide. Which can also be located inside or outside the building, that is, on both sides of the leaves. The preferred and alternative modes are reflected in the dependent claims.

As will be evident to one skilled in the art, the present invention should not be limited to the embodiments described in the present document, with several modifications being possible that remain within the scope of the present invention. Evidently, the preferred modes presented above are combinable, in the different possible ways, avoiding the repetition of all these combinations.

1. Frame with incorporation of protection against external light and/or lighting comprising at least one fixed frame (10), at least one panel (1) with a movable frame (9) characterized by comprising
at least one means of protection against external light (3) and/or at least one lighting means (2), both at least one means of protection against external light (3) and/or at least one lighting means (2) are housed on at least one profile housing profile (7) of the fixed frame (10), said at least one housing profile (7) of the fixed frame (10) is located on at least one point on the lintel of the fixed frame (10) and on at least one side of the panel (1); and
at least two openings (4), said openings (4) being located in the fixed frame (10) in such a way as to project illumination from the lighting means (2) and allowing the external light protection means (3) to slide by vertical movement and parallel to the panel (1).

2. Frame according to claim 1 wherein the means of protection against external light (3) are roller blinds, said roller blinds being inserted into rollers.

3. Frame according to claim 1 wherein the means of protection against external light (3) are moved manually and/or automatically.

4. Frame according to claim 1 wherein the means of protection against external light (3) comprise a weight located at a free end that crosses the opening (4).

5. Frame according to claim 1 wherein the means of protection against external light (3) comprise a variable engagement and the fixed frame (10) comprises fixing means along the jamb, with the variable engagement of the protection means against external light (3) fixed in the fixing means on the fixed frame (10), in the upward-descending movement.

6. Frame according to claim 1 wherein the frame comprises a motor (6), said motor (6) driving the movement of the means of protection against external light (3).

7. Frame according to claim 1 wherein the motor (6) is reversible.

8. Frame according to claim 1 wherein the openings (4) have a width between 8 mm and 18 mm.

9. Frame according to claim 1 wherein the lighting means (2) are located on the outer sides of the external light protection means (3).

10. Frame according to claim 1 wherein the lighting means (2) are LED.

11. Frame according to claim 1 wherein the frame comprises a built-in light sensor.

12. Frame according to claim 1 wherein the external light protection means (3) are made of material against Ultraviolet (UV) radiation.

13. Frame according to claim 1 wherein the frame comprises a temperature sensor.

14. Frame according to claim 1 wherein the frame comprises integrated photovoltaic panels.

15. Frame according to claim 1 wherein the frame comprises a battery located in the housing profile (7) of the fixed frame (10).

16. Frame according to claim 1, wherein the panels (1) are made of panels of single, double, triple glass, or another type of material.

17. Frame according to claim 1 wherein the movable frame (9) and/or the fixed frame (10) are made of aluminium.

18. Frame according to claim 1 wherein the external light protection means (3) are a net with an opening to protect against the entry of mosquitoes or dust, similar to a mosquito net.
